(19) United States
(12) Patent Application Publication
(10) Pub. No.: US 2009/0074594 A1
(43) Pub. Date: Mar. 19, 2009

(54) ARRANGEMENT WITH A VENTILATOR AND A PUMP

(76) Inventor: Gunther Strasser, St. Georgen (DE)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/719,852

(22) PCT Filed: Sep. 6, 2005
(86) PCT No.: PCT/EP2005/009543

§ 371 Date: May 21, 2007

(30) Foreign Application Priority Data
Nov. 19, 2004 (DE) 20 2004 018 458.3

(51) Int. Cl. F04D 25/06; H02K 16/02

(52) U.S. Cl. 417/352; 310/114

(57) ABSTRACT

A compact arrangement features a fan (42′), a fluid pump (134), and an electric drive motor (106). The latter has a stator (22) having a stator winding (118) that is configured to generate a rotating field. The stator (22) has associated with it a permanent-magnet external rotor (106) for driving the fan (42′), and a permanent-magnet internal rotor (140) for driving the fluid pump (134). The stator winding (118) thus drives not only the rotor (106) of the drive motor and hence the fan (42′), but also the internal rotor (140) and hence the fluid pump (134). The arrangement is very well suited for combination with a fluid cooler (90).

### CROSS-REFERENCE

This application is a section 371 of PCT/EP2005/09543, filed 6 Sep. 2005, and published as WO 2006-056 249-A1, claiming priority from DE 20 2004 018 458.3 of 19 Nov. 2004, both of which are hereby incorporated by reference.

### FIELD OF THE INVENTION

The present invention relates to an arrangement having a fan, a pump, and a drive motor.

### BACKGROUND

Arrangements of this kind have a design that requires a great deal of space. This is unfavorable in situations where little space is available, e.g. in medical or electronic devices.

### SUMMARY OF THE INVENTION

It is therefore an object of the invention to make available a novel arrangement having a fan, a pump, and a drive motor.

According to the invention, this object is achieved by arranging for the rotating magnetic field created by the stator to drive both a permanent-magnet external-rotor fan motor and a permanent-magnet internal pump rotor.

A space-saving arrangement is thereby achieved because the same stator drives both a permanent-magnet external rotor and, by way thereof, a fan, as well as a permanent-magnet internal rotor that in turn drives a pump.

A very advantageous embodiment of the invention is to provide a magnetically transparent structural element which makes a hermetic separation of the pump rotor from the stator and the fan rotor. In this case, the stator has an additional function because it surrounds the internal rotor in the manner of a partitioning can.

A further advantageous refinement of the invention is to implement the stator as a coreless winding. A coreless winding means a large air gap, but in the largely homogeneous magnetic field between the external rotor and internal rotor it is possible, with appropriate current flow, to generate a highly constant torque, with the result that such an arrangement runs quietly.

The optimum type of current flow depends on the manner in which the external and internal rotor are magnetized.

### BRIEF FIGURE DESCRIPTION

Further details and advantageous refinements of the invention are evident from the exemplifying embodiments, in no way to be understood as a limitation of the invention, that are described below and depicted in the drawings. In the drawings:

FIG. 1 is a longitudinal section through a highly schematic depiction to explain the basic principles of the invention;

FIG. 2 is a depiction to explain the arrangement according to FIG. 1;

FIG. 3 is a depiction of a coreless winding used in FIGS. 1 and 2, shown in the manner usual in electrical engineering;

FIG. 4 schematically depicts a preferred embodiment of the driver stage for the winding of FIG. 3;

FIG. 5 shows the sequence of current flow in the winding according to FIG. 3 in combination with the circuit according to FIG. 4, for a rotation angle α=360° el.;

FIG. 6 is a longitudinal section through a first exemplifying embodiment of an arrangement according to the present invention, looking along line VI-VI of FIG. 7;

FIG. 7 is a section looking along line VII-VII of FIG. 6;

FIG. 8 is a longitudinal section through a second exemplifying embodiment of an arrangement according to the present invention, looking along line VIII-VIII of FIG. 9;

FIG. 9 is a section looking along line IX-IX of FIG. 8;

FIG. 10 is a detailed depiction showing, for the second exemplifying embodiment, how the external rotor is mated to the stator; and

FIG. 11 is an individual depiction showing, for the second exemplifying embodiment, the appearance of the internal rotor with the pump wheel, and the cover of the pump housing, before assembly thereof.

### DETAILED DESCRIPTION

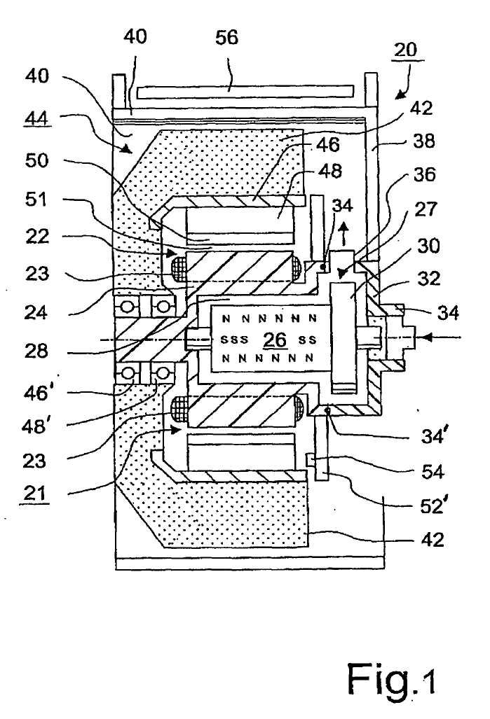

FIG. 1 schematically depicts an arrangement 20 according to the invention. The size of the air gaps, which of course should be very small, is exaggerated for reasons of clarity. This depiction serves essentially to explain the manner of operation. The pump and fan are merely indicated.

Arrangement 20 has a motor 21 comprising a stator 22, which latter is preferably depicted as a coreless winding 23 having a plastic part 24 that surrounds a permanent-magnet internal rotor 26 in liquid-tight fashion in the manner of a partitioning can or hermetic separator and is separated from rotor 26 by an internal air gap 28. In magnetic terms, plastic part 24 also forms part of internal air gap 28, as does external air gap 51 (described below) because it is magnetically transparent. If winding 23 is implemented in coreless fashion, the entire interstice between internal rotor 26 and external rotor 44 constitutes, in magnetic terms, one homogeneous air gap.

Internal rotor 26 drives a hydraulic machine 27, in this case a pump wheel 30. FIG. 11 shows at the top a typical pump wheel that is implemented integrally with an internal rotor. Rotor 26 and pump wheel 30 are enclosed in liquid-tight fashion on the left side by plastic part 24, and on the right side by a pump cover 32 such as the one depicted by way of example in the lower part of FIG. 11. Located between plastic part 24 and pump cover 32 in FIG. 1 is a seal 34′ of arbitrary type. In practice, parts 24 and 32 are adhesively bonded or welded.

Located in pump cover 32 in FIG. 1 are an inlet 34 and an outlet 36 for the fluid to be pumped, e.g. oil in a motor vehicle, or cooling water, or a fluid in a medical device. Rotor 26 and pump wheel 30 are journaled, as depicted in FIG. 1, on the left in plastic part 24 and on the right in pump cover 32. Another type of journaling will be described below.

Plastic part 24 is mounted via radially extending struts 38, only one of which is depicted, on an air guidance housing 40 within which fan blades 42 rotate during operation in order to transport air through this fan housing. An axial fan is depicted, but a diagonal fan or radial fan would be possible in the same fashion. Fan blades 42 are mounted on a permanent-magnet external rotor 44 that is depicted in longitudinal section and is journaled via rolling bearings 46′, 48′ on plastic part 24. A magnetic yoke in the form of a soft iron part 46 is mounted in external rotor 44, which part turns a ring magnet 48 that here is preferably implemented with four poles, as is internal rotor 26.

Located on the radially inner side of ring magnet 48 is a damping arrangement 50, e.g. in the form of a short-circuit cage or a thin-walled ring of sheet copper. A damper of this kind is useful because one of the two rotors usually controls the rotating field of winding 23 via Hall sensors, and because the other rotor then normally follows this rotating field as in the case of a synchronous machine but, for example at startup, any relative motion between internal rotor 26 and external rotor 44 is damped. This prevents rotors 26 and 44 from getting out of step in a context of dynamic processes. Damping arrangement 50 is separated from stator 22 by external air gap 51.

A circuit board 52′ is provided to control the currents in winding 23, on which board three Hall sensors 54 are provided in the case of a winding having three phases; FIG. 1 depicts only one of these sensors, which in this embodiment is controlled by ring magnet 48.

Alternatively, the use of Hall sensors can also be avoided and the rotor position can be determined in sensorless fashion. In this case a circuit board 56 can be arranged externally on housing 40, and the rotor position is then calculated by means of an algorithm, e.g. an algorithm according to EP 0 536 113 B1 and corresponding U.S. Patent RE-39076, von der Heide et al.

A damper 50 proves useful in this case, and such a system can, if applicable, also be provided on internal rotor 26 or on both rotor magnets 26, 48.

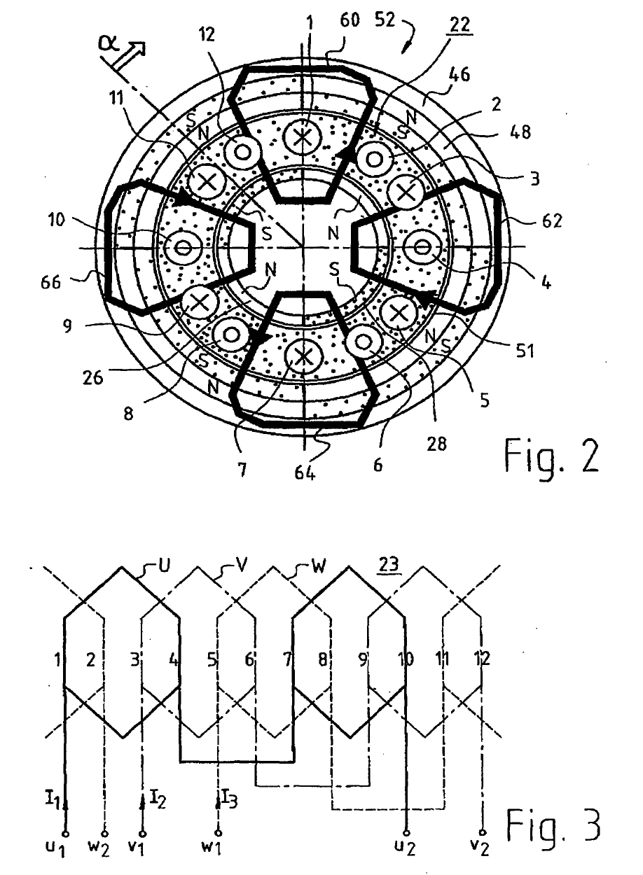

FIG. 2 is a highly schematic section, not to scale, through the arrangement of FIG. 1, and FIG. 3 shows by way of example the configuration of a suitable three-phase winding 23.

Depicted all the way at the outside in FIG. 2 is magnetic yoke 46, in which is located rotor magnet 48 depicted with four poles, whose four radially magnetized poles are indicated with N and S in the usual way. Rotor magnet 48 is separated by external air gap 51 from stator 22, and the latter is in turn separated by internal air gap 28 from the four-pole internal rotor 26.

Stator 22 contains, as shown, twelve uniformly distributed conductors 1 to 12 whose connections are depicted in FIG. 3. Winding 23 depicted in FIG. 3 is a four-pole, three-phase, “twelve-slot” winding with no shortening of the winding pitch. (If a stator core is not used, no slots in the usual sense are present. The use of soft ferromagnetic material in stator 22 is of course not precluded.)

FIG. 3 shows the three phases U, V, and W in a depiction as if twelve uniformly distributed slots 1 to 12 were present. Phase U has two terminals u1 and u2, phase V two terminals v1 and v2, and phase W two terminals w1 and w2. Phase U is shown as a solid black line, phase V as a dot-dash line, and phase W as a dashed line. Phase U proceeds from terminal u1 to slot 1, then to slot 4, then to slot 7 and to slot 10, and from the latter to terminal u2.

Phase V goes v1 to slot 3, then to slots 6, 9, and 12, and from there to v2.

Phase W goes from w1 to slot 5, then to slots 8, 11, and 2, and from there to w2.

Further details are evident from FIG. 3.

The twelve conductors depicted in FIG. 2 are numbered with the same slot numbers 1 to 12 in order to facilitate comprehension.

The angle α is likewise indicated.

Magnet 48 of external rotor 52 and magnetic internal rotor 26 are magnetically coupled to one another, as depicted schematically in FIG. 2 by the four flux lines 60, 62, 64, 66. Pump rotor 26 and fan rotor 52 together form a magnetic flux that is four-poled with respect to air gaps 28 and 51. The two rotors 26 and 52 are thereby positioned relative to one another, as in a magnetic coupling, in the position depicted in FIG. 2, a largely homogeneous magnetic flux being constituted in the air gaps.

With appropriate current flow, winding 23 produces a torque on internal rotor 26 and on external rotor 52. The total torque can be derived from the Lorenz equation as

T=I*B*L*r (1)

where

T=torque;

I=current through a conductor;

B=magnetic flux density in the space (“air gap”) between rotors 26 and 52;

r=radius of the conductor with reference to the rotation axis of rotors 26 and 52.

For the entire arrangement with currents I₁, I₂, I₃ as depicted in FIG. 3, the motor torque T_Motor can be calculated as

T_Motor=ke₁*I₁+ke₂*I₂+ke₃*I₃ (2)

where ke=motor constant.

In normal operation, the angular offset between external rotor 52 and internal rotor 26 is very low, and the torque distribution over the two rotors can be calculated quite accurately by simulation.

In an arrangement having a pump and a fan, it is usually the case that the pump requires more torque than the fan; the effect is as if rotor 26 were being braked, so that (referring to FIG. 2) it lags slightly behind external rotor 52, i.e. the magnetic boundaries are correspondingly shifted with respect to one another, as is readily apparent to one skilled in the art of electrical engineering. The possible relative angular offset of the two rotors is damped by damping ring 50 at the inner radius of external ring magnet 48. If a relative motion occurs between internal rotor 26 and external rotor 52, an electric current is then induced in damping ring 50 and counteracts any relative motion.

In the context of control of the currents in winding 23, a possible angular offset of this kind is taken into account in the ramp-ups, in order to ensure that external rotor 52 can follow internal rotor 26.

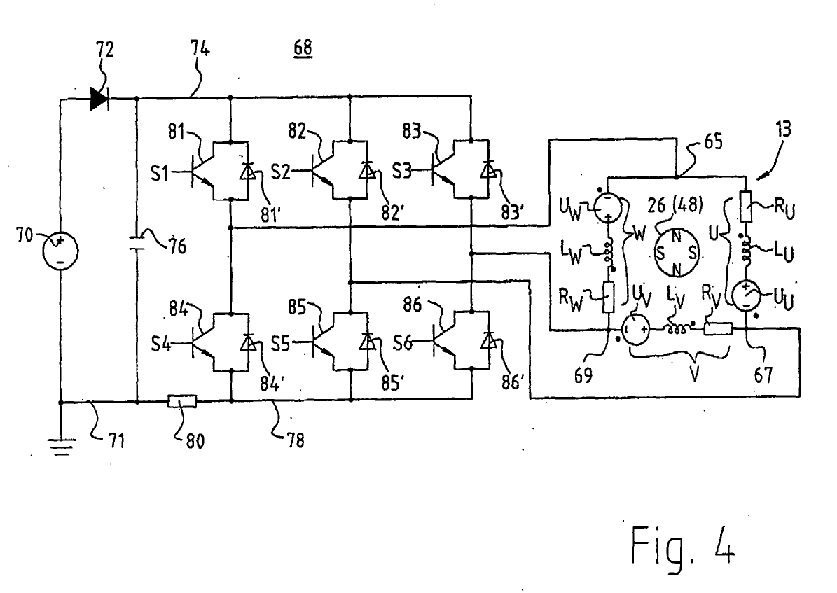

FIG. 4 shows a circuit for supplying current to winding 13 with its three phases U, V, W. The latter are each depicted with their inductive component (e.g. Lu), their resistive component (e.g. Ru), and their induced voltage (e.g. Uu), as is done in a computer simulation. (The coupling inductances, which are likewise taken into account in a simulation, are not depicted.) A delta circuit is depicted, its connection points being labeled 65, 67, and 69.

A full bridge circuit 68, often also referred to as an inverter, serves to supply current to winding 13. This circuit obtains its current from a DC voltage source 70, e.g. a vehicle battery or the power supply of a computer. DC voltage source 70 is connected at its negative pole to ground 71. Its positive pole feeds a positive lead 74, also called a DC link, via a diode 72 that prevents misconnection. A storage capacitor of, for example, 4700 μF is arranged between lead 74 and ground 71. Said capacitor supplies the full bridge circuit with reactive power.

Full bridge circuit 68 has three upper npn transistors 81, 82, 83 and three lower npn transistors 84, 85, 86, each of which has a respective free-wheeling or recovery diode 81′ to 86′ connected antiparallel with it.

The collectors of upper transistors 81, 82, 83 are connected to positive lead 74. The emitters of lower transistors 84, 85, 86 are connected to a negative lead 78 that is connected via a measuring resistor 80 to ground 71. Measuring resistor 80 is part of a current limiter (not depicted).

The emitter of transistor 81 and the collector of transistor 84 are connected to node 65.

The emitter of transistor 82 and the collector of transistor 85 are connected to node 67.

The emitter of transistor 83 and the collector of transistor 86 are connected to node 69.

Transistors 81 to 86 are controlled by signals s1 to s6, as depicted in FIG. 4. For example, if s1=1 then transistor 81 is conductive, and if s1=0 it is blocked.

FIG. 2 shows an angle α that, in the position of the rotor poles relative to stator 22 that is depicted, has a value of 0, which increases upon clockwise rotation of the rotors.

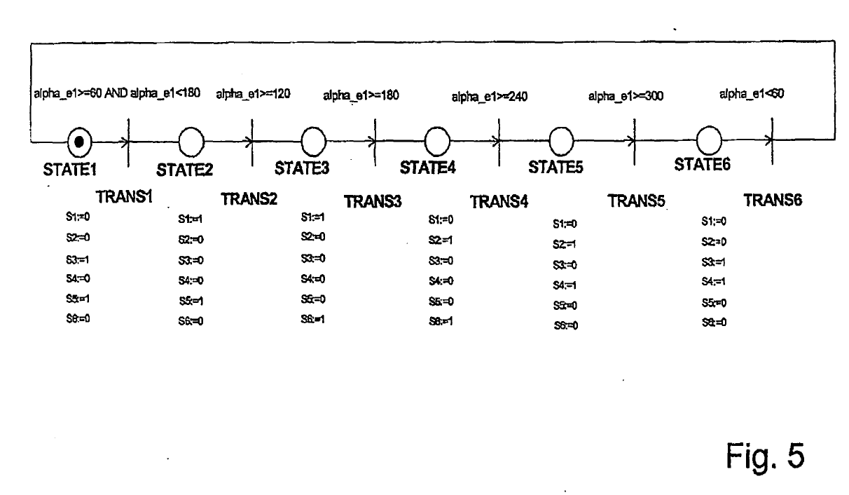

FIG. 5 shows values s1 to s6 for the various values of α.

In the STATE 1 state, corresponding to startup, s3 and s5=1, i.e. transistors 83 and 85 are conductive and the other transistors are blocked, so that a current flows from node 69 to node 67.

The circuit leaves state 1 and goes to STATE 2 when a transition state TRANS 1 is reached at which α>=60° el.

In the STATE 2 state, which therefore normally corresponds to an angle α between 60 and 120° el., s1 and s5=1 and a corresponding current flow takes place.

In the TRANS 2 state, when a has become greater than or equal to 120°, the transition to the STATE 3 state occurs. In this, s1 and s6=1.

When α>=180° el. (TRANS 3), the transition occurs to STATE 4, in which s2 and s6=1.

The subsequent transitions are as follows:

TRANS 4 at α>=240° el.

TRANS 5 at α>=300° el.

TRANS 6 at α<60° el.

Signals s1 to s6 for the various rotation angle ranges are indicated in FIG. 5. A normal block commutation system is therefore preferably used, i.e. the currents are delivered in the form of current blocks whose amplitude can be modified by means of a PWM (Pulse Width Modulation) control system.

Angle α can be measured in sensorless fashion (cf. the aforementioned European Patent 0 536 113 B1 and U.S. Patent RE-39076).

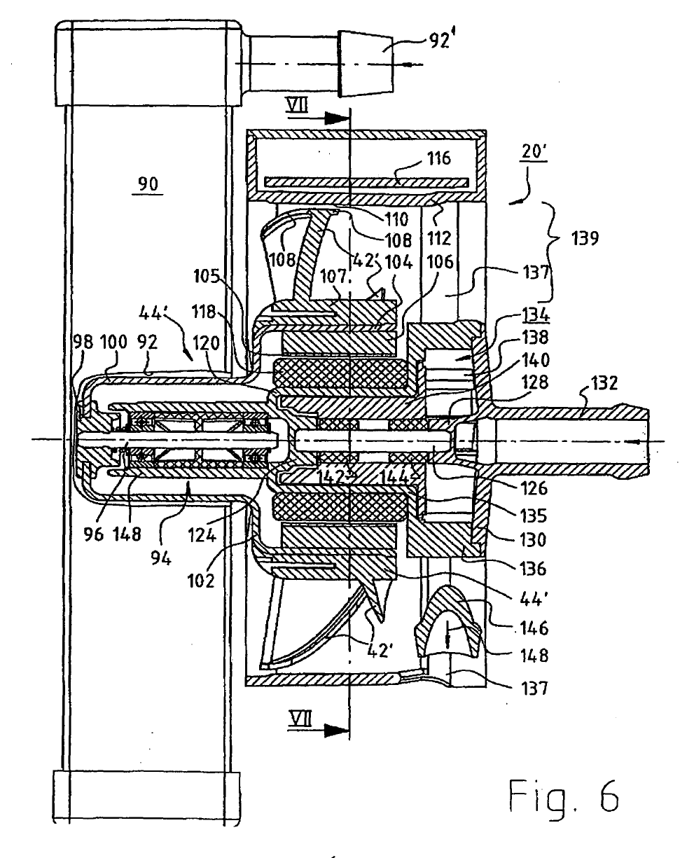

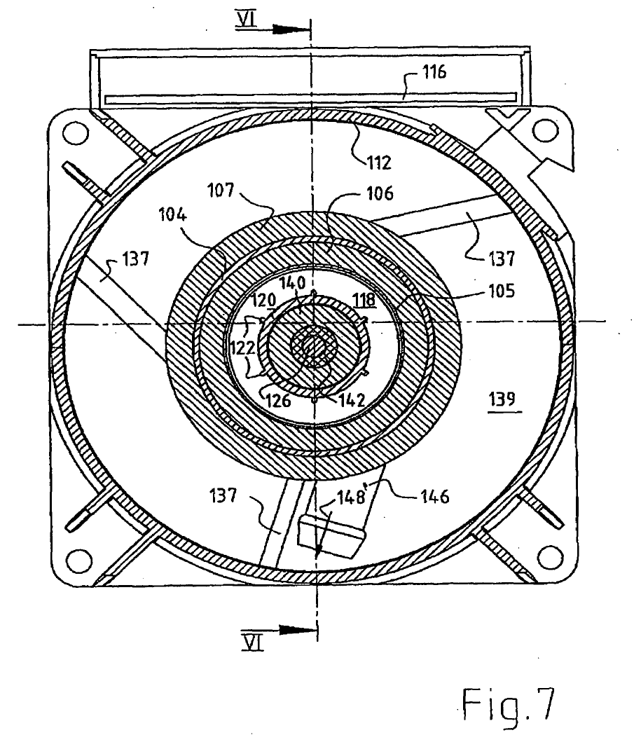

FIGS. 6 and 7 show a first exemplifying embodiment for a practical implementation of an arrangement according to the present invention. Parts identical, or functioning identically, to ones in FIGS. 1 to 5 are labeled with the same reference characters but with an apostrophe added, e.g. 52′ instead of 52, and are usually not described again.

FIG. 6 shows at the left a liquid cooler 90 whose inlet is labeled 92′. (The outflow is not depicted in FIG. 6.) This cooler 90 has at the center an opening 92 into which a bearing portion 94 of arrangement 20′ projects. Fan blades 42′ are implemented so that they either blow air through cooler 90, i.e. from right to left, or draw air through the cooler from left to right.

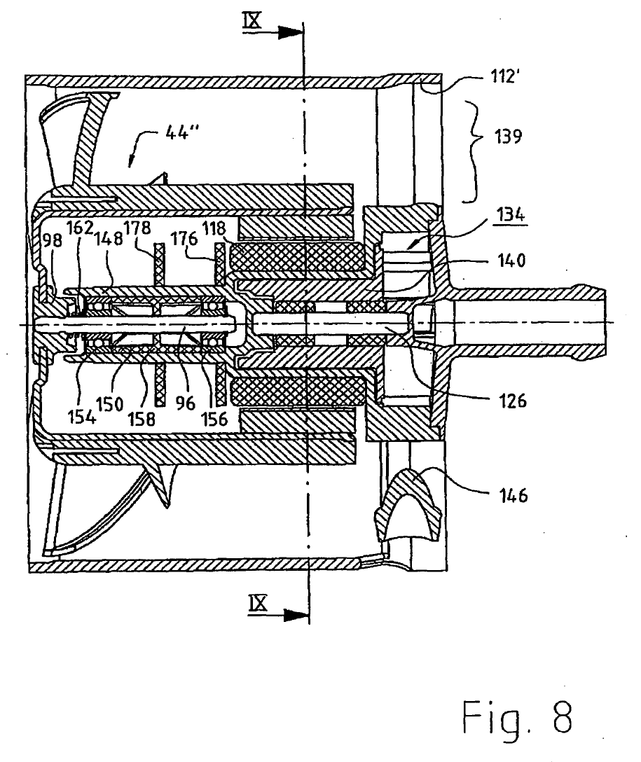

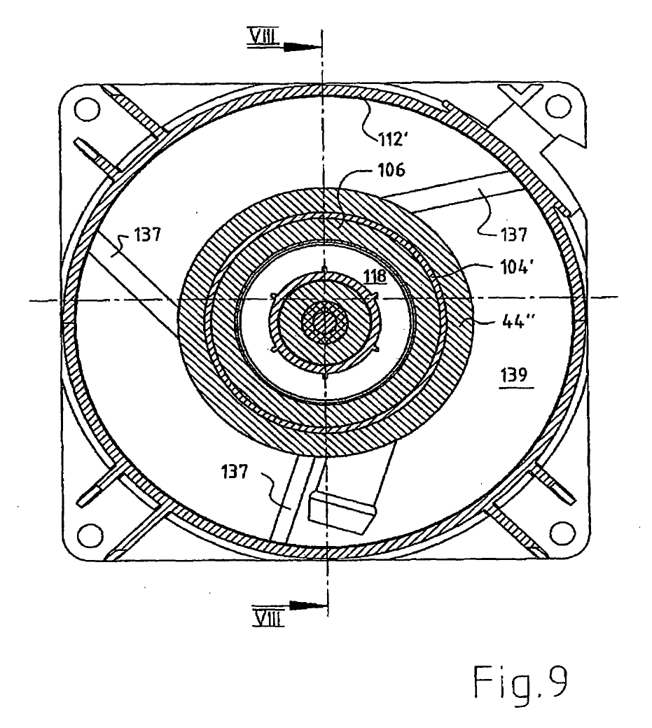

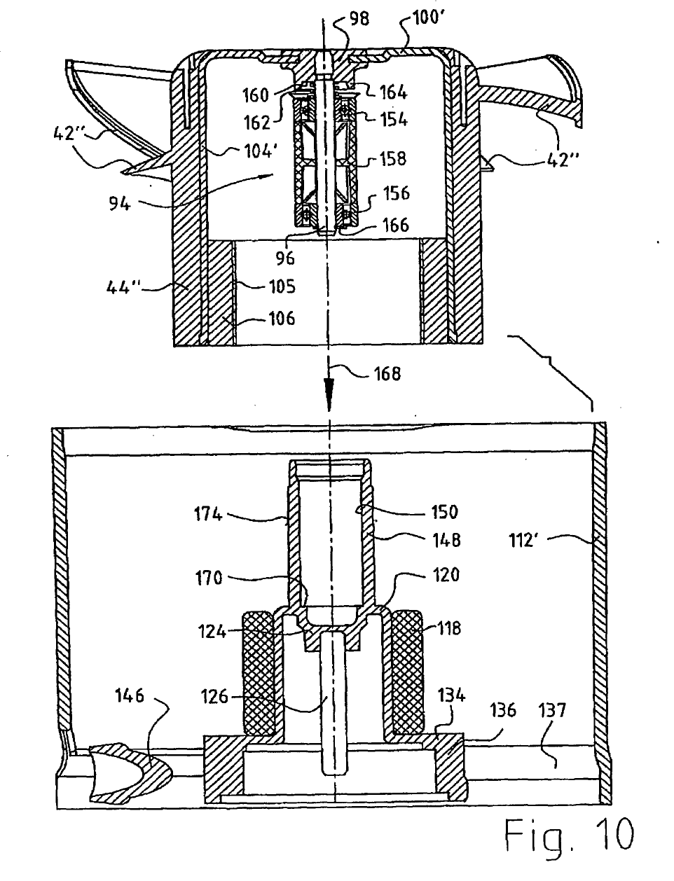

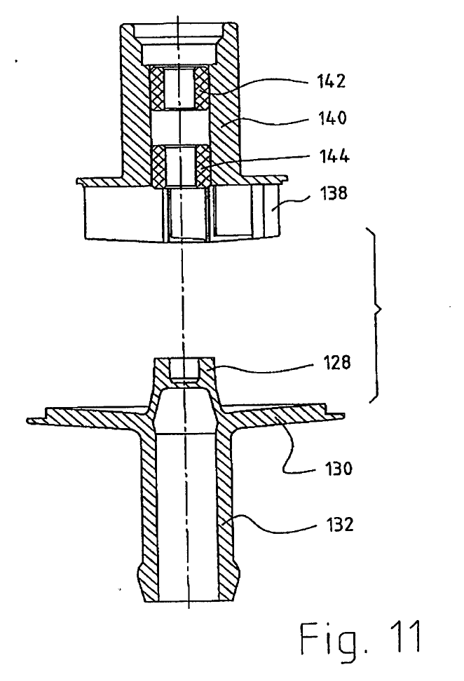

Bearing portion 94 serves to journal an external rotor 44′. The construction of the bearing system corresponds to that shown in FIGS. 8 and 10 and is therefore described there.

Journaled in bearing system 94 is a shaft 96 connected to which, via a hub 98, is a rotor cup 100. Where it projects into cooler 90, said cup has a smaller diameter, which widens via a portion 102 into a rotor cup 104 of greater diameter in which is arranged a four-pole permanent magnet 106 for which rotor cup 104 serves as a magnetic yoke. This permanent magnet 106 has a copper layer 105 on its radially inner side in order to permit asynchronous startup. On its outer side, rotor cup 104 is injection-embedded in a plastic sheath 107 with which blades 42′ are integrally formed. Blades 42′ have on their outer side air-directing elements 108 that extend in an axial direction and reduce the air flow that flows, through gap 110 between a blade tip and fan housing 112, from the delivery side of the fan to its intake side. This reduces fan noise.

Located on the outer periphery of fan housing 112 is a closed cavity 114 in which a circuit board 116, which serves to control the motor, is arranged.

Located radially inside external rotor 106 is a coreless stator winding 118 that is preferably implemented as a three-phase winding to generate a rotating field, as described with reference to FIG. 1. This winding is supplied with a three-phase current from circuit board 116. Circuit board 116 can be connected, for example, to a source for a three-phase current or to a DC power network.

Stator winding 118 is located on the outer side of a partitioning can 120 that is equipped, for this purpose, with guidance projections 122. These projections 122 serve to mount winding 118 in the desired angular position on partitioning can 120. Partitioning can 120 is implemented as a magnetically transparent part, preferably made of plastic.

Mounted inside partitioning can 120 in an axial projection 124 is a stationary shaft 126 whose right end in FIG. 6 is guided in an axial projection 128 of a pump cover 130 that is equipped with an inlet connecting pipe 132. During operation, cooling liquid flows through pipe 132 to a centrifugal pump 134.

Partitioning can 120 widens on its right side in FIG. 6, via a radially extending portion 135, into a hollow-cylindrical portion 136 of greater diameter in which a pump wheel 138 rotates during operation. This portion 136 is connected to fan housing 112 via three struts or spokes 137. These struts 137 extend transversely to an annular air passage 139.

This pump wheel 138 has an extension 140, projecting in FIG. 6 to the left, made of magnetizable material, e.g. made of plastic with embedded hard ferrite particles, and this extension 140 is here magnetized (like ring magnet 106) with four poles and is located radially inside coreless winding 118, from which it is separated in liquid-tight fashion by partitioning can 120. Extension 140 is equipped on its inner side with two sintered bearings 142, 144 by means of which it is rotatably journaled on shaft 126. Axial extensions 124 and 128 form axial bearings for extension 140 and for pump wheel 138 integral therewith.

An outlet pipe 146 proceeds approximately tangentially outward from hollow-cylindrical portion 136. The flow through direction is indicated in FIG. 7 by an arrow 148′.

### Manner of Operation

In operation, stator winding 118 is supplied with current from circuit board 116 in such a way that said winding generates a rotating electromagnetic field. As described in detail with reference to FIG. 2, this rotating field drives both external rotor magnet 106 and internal rotor magnet 140. Any relative motion of rotor magnets 106, 140 is damped by copper layer 105.

Both external rotor magnet 106 having fan blades 42′, and internal rotor 140 having pump wheel 130, are therefore synchronously driven in this fashion by winding 118. A very compact design with reliable operation results, and arrangement 20′ can be combined directly with a liquid cooler 90, as depicted in FIG. 6.

FIG. 8 shows a second exemplifying embodiment of the invention. Identical or identically functioning parts are labeled with the same reference characters as in the previous Figures, and usually are not described again.

As is apparent, the configuration of the two motors and the pump is unchanged as compared with the first exemplifying embodiment (FIGS. 6 and 7). The configuration of external rotor 44″ is different, however, and fan housing 112′ is correspondingly longer than fan housing 112 in FIGS. 6 and 7.

As in FIGS. 6 and 7, bearing portion 94 has a bearing tube 148 that is implemented integrally with partitioning can 120 and has a cylindrical internal opening 150 (cf. FIG. 10).

FIG. 10 shows, in its upper part, the corresponding bearing arrangement. The latter has two rolling bearings 154, 156 whose inner rings are axially displaceable on shaft 96. Located between the outer rings of bearings 154, 156 is a spacing member 158 that is likewise axially displaceable on shaft 96 and has a somewhat smaller diameter than cylindrical internal opening 150.

Here as well, a hub 98, on which a rotor cup 100′ is mounted, is mounted on the upper end (in FIG. 10) of shaft 96. Said cup has in this case a continuously cylindrical portion 104′ (of constant diameter) whose lower part in FIG. 10 serves as a magnetic yoke for rotor magnet 106 of the external rotor. Fan blades 42″, which have the same shape as blades 42′ in FIG. 6, are mounted in the manner depicted on the outer side of the upper part of cylindrical portion 104′.

Hub 98 has a depression 160 on its lower side (in FIG. 10), and a compression spring 162 is arranged between said depression and the inner ring of upper rolling bearing 154.

Depression 160 is delimited toward the outside in FIG. 10 by a downwardly projecting rim 164 that, when spring 162 is compressed, abuts against the outer ring of the upper rolling bearing 154.

A snap ring 166 is mounted at the lower end of shaft 96, and the inner ring of lower rolling bearing 156 is pressed by spring 162 against this snap ring 166.

Upon assembly, bearing arrangement 94 is pressed into opening 150 of bearing tube 148 in the direction of an arrow 168. Spring 162 is thereby compressed so that rim 164 pushes against the outer ring of upper rolling bearing 154, and this outer ring pushes via spacing member 158 against the outer ring of lower rolling bearing 156, so that the entire bearing arrangement 94 becomes pressed into bearing tube 148 until the outer ring of lower rolling bearing 156 abuts against a shoulder 170 (FIG. 10) of internal opening 150.

Spring 162 then relaxes, and thereby displaces shaft 96 upward until snap ring 166 abuts against the inner ring of lower rolling bearing 156, as shown by FIGS. 6, 8, and 10. The assembly of bearing arrangement 94 is then complete, and it is not necessary to perform further work for this purpose in the interior of bearing tube 148.

As FIG. 8 shows, bearing tube 148 has a cylindrical outer side 174, and mounted thereon are two circuit boards 176, 178 that carry the electronic components for controlling the currents in coreless winding 118. Hall sensors (not depicted), which serve to sense the position of internal pump rotor 140 and to control the commutation of coreless winding 118, can be arranged on circuit board 176 that is located closer to winding 118. Because these currents are consequently controlled by the position of internal rotor 140, the latter also determines the rotation speed of external fan rotor 106, although external rotor 106 can exhibit a certain slippage upon startup with respect to the rotating field generated by winding 118. As already described, copper layer 105 is provided for this reason.

FIG. 11 shows, at the bottom, pump cover 130 with its inlet connection pipe 132 and part 128 equipped with radial holes, in which part the lower end (in FIG. 10) of shaft 126 is retained.

FIG. 11 also shows centrifugal pump wheel 138 and internal rotor 140 with the two sintered bearings 142, 144 that rotate on stationary shaft 126, as described with reference to FIG. 6.

Many variants and modifications are of course possible within the scope of the present invention.

What is claimed is:

1. An arrangement having a fan (42; 42′, 42″) and a fluid pump (27; 134), and having an electric drive motor (21; 106), which motor comprises
a stator (22) having a stator winding (23; 118) that is configured for generating a rotating field,
which stator (22) has associated with it a permanent-magnet external rotor (48; 106) for driving the fan (42; 42′, 42″) and a permanent-magnet internal rotor (26; 140) for driving the fluid pump (27; 134), said rotors both magnetically interacting with said rotating field generated by said stator, so that, in operation, said rotors are driven by said rotating field.

2. The arrangement according to claim 1, wherein
the internal rotor (26; 140) is separated from the stator (22) by a magnetically transparent part (24; 120) that hermetically separates the internal rotor (26; 140) from the external rotor (48; 106).

3. The arrangement according to claim 1, wherein
the stator winding is implemented as a coreless winding (23; 118).

4. The arrangement according to claim 1, wherein
the number of poles of the external rotor (48; 106) matches the number of poles of the internal rotor (26; 140).

5. The arrangement according to claim 1, wherein
at least one of the permanent-magnet rotors has associated with it a damping member (50; 105) that enables said rotor to run asynchronously.

6. The arrangement according to claim 5, wherein
the damping member is implemented as a short-circuit cage (50; 105).

7. The arrangement according to claim 6, wherein
the damping member (50; 105) is implemented as an eddy-current damper.

8. The arrangement according to claim 1, wherein
the fan comprises fan blades (42′; 42″) that, during operation, rotate in an air guidance housing (40; 112; 112′).

9. The arrangement according to claim 8, wherein
an air guidance passage (139) is defined between the air guidance housing (40; 112; 112′) and the fluid pump (27; 134).

10. The arrangement according to claim 9, wherein
the air guidance housing (40; 112; 112′) is connected to the fluid pump (27; 134) by at least one mechanical connecting element (38; 137).

11. The arrangement according to claim 9, wherein
the mechanical connecting element (38; 137) extends transversely to the air guidance passage (139).

12. The arrangement according to claim 9, wherein the mechanical connecting element (38; 137), the air guidance housing (112; 112′), and an element (136) of the fluid pump (134) are implemented as one integral plastic part (FIG. 10).

13. The arrangement according to claim 1, wherein the fluid pump is implemented as a centrifugal pump (134).

14. The arrangement according to claim 13, wherein
the centrifugal pump (134) comprises a pump wheel (138) that is implemented integrally with the permanent-magnet internal rotor (26; 140).

15. The arrangement according to claim 14, wherein
the internal rotor (26; 140) is separated from the stator (22) by a magnetically transparent partitioning can (24; 120) that is implemented as an element of a stationary part (136) of the centrifugal pump (134).

16. The arrangement according to claim 2, wherein the stator winding is implemented as a coreless winding.

17. The arrangement according to claim 16, wherein at least one of the permanent-magnet rotors has, associated with it, a damping member that enables said rotor to run asynchronously.

18. The arrangement according to claim 2, wherein at least one of the permanent-magnet rotors has, associated with it, a damping member that enables said rotor to run asynchronously.

19. The arrangement according to claim 3, wherein at least one of the permanent-magnet rotors has, associated with it, a damping member that enables said rotor to run asynchronously.

20. The arrangement according to claim 4, wherein at least one of the permanent-magnet rotors has, associated with it, a damping member that enables said rotor to run asynchronously.
